(19) United States
(12) Patent Application Publication
(10) Pub. No.: US 2009/0098832 A1
(43) Pub. Date: Apr. 16, 2009

(54) MOBILE DEVICE POWERED BY ALTERNATIVE ENERGY

(76) Inventor: Benjamin Johnson, Modesto, CA (US)

Correspondence Address: KEVIN J. MACK, 112 MAPLE LN, E. PALO ALTO, CA, 94303, US

(21) Appl. No.: 11/872,033

(22) Filed: Oct. 14, 2007

(51) Int. Cl. H04B 1/38

(52) U.S. Cl. 455/73

(57) ABSTRACT

A mobile device and a method for powering a mobile device are disclosed. In some embodiments, the mobile device comprises a processor that executes instructions for mobile applications, a transceiver that sends and receives data related to the mobile applications, a primary power cell that couples to the processor and the transceiver, an alternative power cell that couples to the processor and the transceiver and that generates electrical power from a renewable power source, and a switch that enables the primary power cell and the alternative power cell to power the processor and the transceiver.

### FIELD OF THE INVENTION

The invention relates generally to mobile devices, and more particularly, to powering the components of mobile devices.

### BACKGROUND

Mobile devices enable users to perform tasks once conducted only in the office or at home. For example, today's conventional cellular phone enables a user to send email, browser the Internet, schedule tasks, and conduct word processing all from a single device. The user has access to these functions wherever the user physically resides, as long as the mobile device is in the user's possession. These conventional mobile devices generally rely on a power cell to supply power and fuel the device. Typically, this power cell comprises a rechargeable battery, such as a lithium-ion battery. The user must recharge the battery whenever it is depleted for continued operation of the mobile device.

Conventional mobile devices, however, for suffer from several shortcomings. First, conventional mobile devices do not include a power source with the capacity of powering the device for extended durations. For example, if a convention mobile device is powered on during a long trip, the mobile device will continually drain its power supply until it is depleted. Second, conventional mobile devices generally require a traditional power source, such as an alternating current (AC) or direct current (DC) power outlet, to recharge the device. If a traditional power source is not available, the mobile device cannot be recharged. Lastly, conventional mobile devices typically rely on a single power cell. If the power cell becomes inoperable, for example, because exposed to water, the mobile device also becomes inoperable.

Thus, what is needed is a system and corresponding method that alleviates some or all of the aforementioned shortcomings.

### BRIEF SUMMARY

A mobile device and a method for powering a mobile device are disclosed. In some embodiments, the mobile device comprises a processor that executes instructions for mobile applications, a transceiver that sends and receives data related to the mobile applications, a primary power cell that couples to the processor and the transceiver, an alternative power cell that couples to the processor and the transceiver and that generates electrical power from a renewable power source, and a switch that enables the primary power cell and the alternative power cell to power the processor and the transceiver.

### BRIEF DESCRIPTION OF THE DRAWINGS

For a detailed description of exemplary embodiments of the invention, reference will now be made to the accompanying drawings in which:

FIG. 1 illustrates a mobile device constructed in accordance with embodiments of the invention;

FIG. 2 shows an exemplary mobile device with a solar panel in accordance with embodiments of the invention; and

FIG. 3 illustrates a flow chart of an exemplary process for powering a mobile device.

### NOTATION AND NOMENCLATURE

In the following discussion and in the claims, the terms “including” and “comprising” are used in an open-ended fashion, and thus should be interpreted to mean “including, but not limited to”. Also, the term “couple, “couples,” or “coupled” is intended to mean either an indirect or direct electrical or communicative connection. Thus, if a first device couples to a second device, that connection may be through a direct connection, or through an indirect connection via other devices and connections. In addition, the term “data source” should be interpreted to mean any source of data. For example, a database storing information created by two or more entities represents a plurality of data sources.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

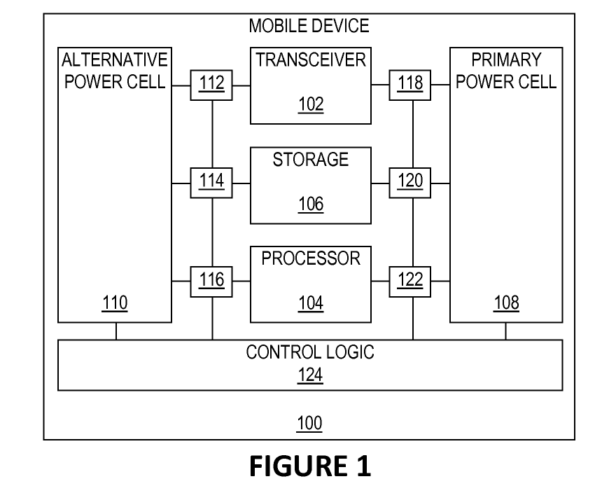

FIG. 1 illustrates a mobile device 100 constructed in accordance with embodiments of the invention. As shown in FIG. 1, the mobile device 100 comprises a transceiver 102, a processor 104, a storage 106, a primary power cell 108, an alternative power cell 110, and a plurality of switches 112-122. Both the primary power cell 108 and the alternative power cell 110 couple to the transceiver 102, the processor 104, and the storage 106 through the switches 112-122. While the primary power cell 108 may represent a conventional power source, such as a nickel metal-hydride (NiMH), Nickel-Cadmium (NiCad), alkaline, lithium-ion, and carbon zinc battery, the alternative power cell 110 represents a device for creating energy from alternative and renewable sources, such as solar, lunar, wind, biofuel, and kinetic energy. Thus, the alternative power cell 110 utilizes natural resources, such as sunlight, moonlight, wind, tides, motion, and geothermal heat, which are naturally replenished. For example, the alternative power cell 110 may represent a solar cell that that converts light energy into electrical energy. Generally, photons may strike the solar cell, which typically is made of a silicon based substance, and the solar cell absorbs a portion of the energy associated with the photon and converts the energy into electrical energy. Similarly, the alternative power cell 110 may represent a kinetic device that transforms the motion of the mobile device 100 into electrical energy.

The storage 106 may represent any type of volatile and/or non-volatile memory, such as random access memory (RAM) and read only memory (ROM), or any other medium for storing information, such as a hard drive, universal serial bus (USB) flash drive, and memory stick. The storage 106 may couple to the primary power cell 108 through the switch 120 and may couple to the alternative power cell 110 through the switch 114.

The processor 104 may represent any type of software and/or hardware that is capable of processing data related to the mobile device 100, such as Intel's PXA27x family of microprocessors, Texas Instruments' TCS3500 chip set, Intel's Core Duo processor, and a field programmable gate array (FPGA). The processor 104 preferably includes a clock or oscillator that provides timing for the components of the mobile device 100. In at least some embodiments, the timing for the mobile device 100 is provided by a phase-locked-loop (PLL) circuit. The processor 104 may process, decode, convert, modify, arrange, and/or transform data associated with the mobile display 100. For example, the processor 104 may execute instructions related to mobile applications, such as text messaging, word processing, Internet browsing, and various mobile multimedia applications. The processor 104 may couple to the primary power cell 108 through the switch 122 and may couple to the alternative power cell 110 through the switch 116.

The transceiver 102 may represent any device for sending and receiving short range or long range wireless signals, such as a cellular transceiver, a Bluetooth transceiver, and an infrared transceiver. The transceiver 102 may couple to the primary power cell 108 through the switch 118 and may couple to the alternative power cell 110 through the switch 112.

The switches 112-122 may represent any type of circuit for controlling the flow of electrical power to the components of the mobile device 100. The switches 112-122 ensure that either the primary power cell 108 or the alternative power cell 110 powers the transceiver 102, the processor 104, and the storage 106 at all times. Because each switch 112-122 is preferably independent, either the primary power cell 108 or the alternative power cell 110 may power each component of the mobile device 100. For example, the primary power cell 108 may power the transceiver 102, while the alternative power cell 110 powers the processor 104.

Although not explicitly shown in FIG. 1, the mobile device 100 may also comprise a display. The display may represent an LCD display, a plasma display, a grid of light emitting diodes (LEDs), or any other means of displaying content, such as photosensors, electronic ink, organic light-emitting diodes (OLEDs), transparent OLEDs, and solid state lighting (SSL) LEDs. LEDs are semiconductor devices that emit light when electrically biased in the forward direction. The color of the emitted light depends on the chemical composition of the semiconducting material used, and can be near-ultraviolet, visible or infrared. In at least some embodiments, the display is a high definition display operating at a resolution of 1080i/p, i.e., 1920×1080 at 50-60 Hz frame rate, HDTV 1440p, UHDV 2540p, or UHDV 4320p. In whichever resolution selected, the display 122 may be positioned in either a landscape or portrait orientation as desired. In addition, the mobile device may comprise an MP3 player, a global position system (GPS), a sound card, a camera, an atomic clock receiver, a flash drive interface, signal amplifiers, and any other peripheral designed for mobile use. In at least some embodiments, the mobile device 100 lacks the primary power cell 108. In these embodiments, the alternative power cell 110 is configured to completely power the mobile device 100. In other embodiments, the transceiver 102, the processor 104, and/or the storage 106 are designed to consume as little power as possible. For example, the processor 104 may represent a low-power microprocessor designed to operate with a limited amount of power. The mobile device 100 may represent a mobile or cellular phone, a PDA, a pocket PC, a laptop, and any other mobile device.

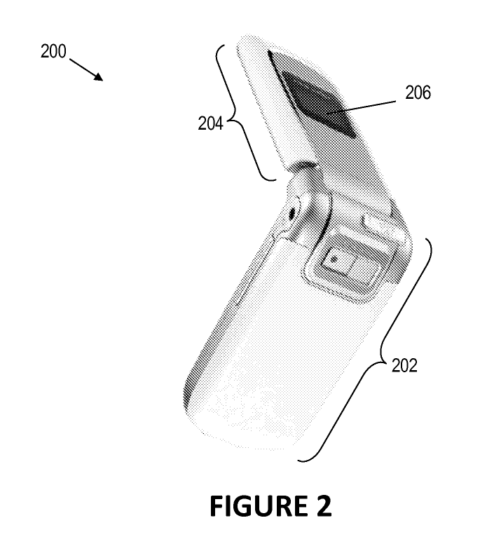

FIG. 2 shows an exemplary mobile device with a solar panel in accordance with embodiments of the invention. As shown in FIG. 2, the mobile device 200 comprises a lower frame 202, an upper frame 204, and a solar panel 206. The lower and upper frames 202-204 are preferably made of a durable and rigid material so as to withstand the stress placed on the mobile device 200 by a user. The solar power panel 206 may represent any type of module designed to convert solar energy into electrical energy. For example, the solar panel 206 may comprise a plurality of photovoltaic cells. Each photovoltaic cell preferably has a glass covering and a frame made of metal, plastic, or fiberglass.

The solar panel 206 is configured to either partially or totally power the mobile device 200. Generally, the larger the surface area of the solar panel 206, the more electrical energy may be produced. The solar panel 206 may be the only power source for the mobile device 200 or may operate in conjunction with another power source, such as a battery and another alternative power source. For example, the mobile device 200 may comprise the solar panel 206 and a kinetic power generator. The solar panel 206 and the kinetic power generator may collectively power the mobile device 206 with or without a battery. Although the solar panel 206 is shown on the back of the upper frame 204, the solar panel 206 may reside at any suitable location, such as on the top, or bottom, and/or sides of the mobile device 200. In addition, although only one solar panel 206 is shown in FIG. 2, the mobile device 200 may comprise a plurality of solar panels strategically placed to maximize the amount of solar energy obtained.

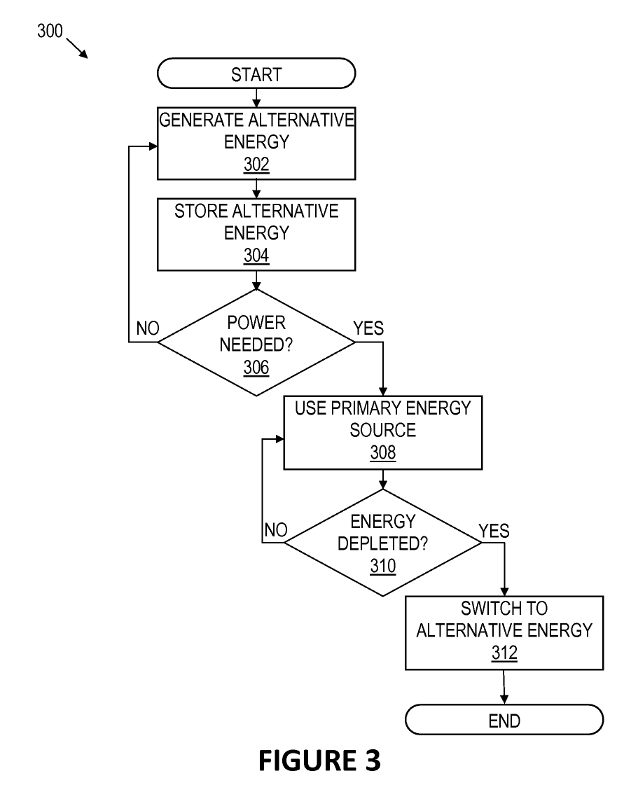

FIG. 3 illustrates a flow chart of an exemplary process for powering a mobile device. The process 300 starts when the mobile device generates alternative power (302). As previously discussed, the alternative power may include solar, lunar, wind, biofuel, kinetic, and any of form of alternative energy. After generating the alternative energy, the mobile device stores the alternative energy (304). If power is not needed (306), for example because the mobile device is powered off, the mobile device continues to generate alternative energy (302) and store it (304). If power is needed (306), the primary energy source is utilized (308) until the primary source is depleted (310). After the primary source is depleted (310), the mobile device switches to alternative energy (312) and the process 300 ends. The alternative energy may be stored in the mobile device in step 304, or may be directly used after generating the energy in step 302. Numerous steps may be added, removed, or reordered as desired. For example, the primary energy source and the alternative energy may be used simultaneously by the mobile device. Components of the mobile device requiring a relatively high amount of energy to operate, such as the processor and transceiver, may utilize the primary source and the lower powered component may utilize alternative energy.

The above discussion is meant to be illustrative of the principles and various embodiments of the present invention. Numerous variations and modifications will become apparent to those skilled in the art once the above disclosure is fully appreciated. For example, each of the components of the mobile device may enter into a low power state after a predetermined length of inactivity to conserve power. It is intended that the following claims be interpreted to embrace all such variations and modifications.

What is claimed is:

1. A mobile device, comprising:
a processor that executes instructions for mobile applications;
a transceiver that sends and receives data related to the mobile applications;
a primary power cell that couples to the processor and the transceiver;
an alternative power cell that couples to the processor and the transceiver and that generates electrical power from a renewable and natural power source; and
a switch that enables the primary power cell and the alternative power cell to power the processor and the transceiver.

2. The mobile device of claim 1 wherein the alternative power cell comprises a solar cell.

3. The mobile device of claim 1 wherein the alternative power cell comprises a kinetic power cell.

4. The mobile device of claim 1 wherein the switch is configured to selectively change a connection from the primary power cell to the alternative power cell.

5. The mobile device of claim 1 wherein the alternative power cell is positioned on an outer surface of the mobile device.

6. The mobile device of claim 1 further comprising a storage that holds the data and that couples to the primary power cell and the alternative power cell.

7. The mobile device of claim 6 wherein the switch enables the primary power cell and the alternative power cell to power the storage.

8. The mobile device of claim 7 wherein the processor is configured to enter a low power state when not in use.

9. A method for powering a mobile device, comprising:
collecting energy from a renewable and natural source;
converting the energy into electrical energy;
storing the electrical energy; and
powering a component of the mobile device with the electrical energy.

10. The method of claim 9 wherein collecting energy from a renewable and natural source comprises collecting solar energy.

11. The method of claim 9 wherein collecting energy from a renewable and natural source comprises collecting kinetic energy.

12. The method of claim 9 wherein storing the electrical energy compromises charging a battery.

13. The method of claim 9 further comprises selectively switching between a conventional power source and the electrical energy.

14. A mobile device, comprising:
a means for executing instructions for mobile applications;
a means for sending and receiving data related to the mobile applications;
a primary means for powering the mobile device that couples to the means for executing instructions for mobile applications and the means for sending and receiving data related to the mobile applications;
an alternative means for powering the mobile device that couples to the means for executing instructions for mobile applications and the means for sending and receiving data related to the mobile applications and that generates electrical power from a renewable power source; and
a means for switching between the primary means for powering the mobile device and the alternative means for powering the mobile device.

15. The mobile device of claim 1 wherein the alternative means for powering the mobile device comprises a means for collecting solar energy solar energy.

16. The mobile device of claim 1 wherein the alternative means for powering the mobile device comprises a means for collecting solar energy kinetic energy.

17. The mobile device of claim 1 wherein the means for switching is configured to selectively change a connection from the primary means for powering the mobile device to the alternative means for powering the mobile device.

18. The mobile device of claim 17 further comprising a means for storing the data that couples to the primary means for powering the mobile device and the alternative means for powering the mobile device.

19. The mobile device of claim 18 wherein the means for switching enables the primary means for powering the mobile device and the alternative means for powering the mobile device to power the means for storing the data

20. The mobile device of claim 19 wherein the means for executing instructions is configured to enter a low power state when not in use.
